(19) United States
(12) Patent Application Publication
(10) Pub. No.: US 2009/0259513 A1
(43) Pub. Date: Oct. 15, 2009

(54) Shipment Management Systems and Methods

(75) Inventors: Lieh Cheung Andrew Tung, Hong Kong (CN); Wai Hung Tam, Tsing Yi (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: OOCL (Infotech) Holdings Limited, Tortola (GB)

(21) Appl. No.: 12/371,112

(22) Filed: Feb. 13, 2009

Related U.S. Application Data
(60) Provisional application No. 61/029,242, filed on Feb. 15, 2008.

(51) Int. Cl. G06Q 10/00; G06F 15/16

(52) U.S. Cl. 705/9; 705/28; 709/204; 705/7

(57) ABSTRACT

A computer implemented system and method for managing and tracking cargo shipments through a supply chain. The system includes a core domain and a party domain. In the core domain, electronic representations of one or more core processes may be generated and maintained that includes a sequence of events and/or milestones representing real world actions associated with the shipping chain. In the party domain, electronic representations of one or more party processes may be generated and maintained that represent a sequence of various events and/or milestones that a party to the shipping chain must undertake. The core domain may generate and communicate events representative of actions that have been or should be undertaken by the parties. The events may be communicated to the party domain where the events can trigger or realize milestones indicating to the party it should undertake various real world actions relating to the shipping chain.

### CROSS-REFERENCE TO RELATED APPLICATIONS

This patent application claims the benefit of U.S. Provisional Patent Application No. 61/029,242, filed on Feb. 15, 2008, which is incorporated by reference in its entirety.

### BACKGROUND OF THE INVENTION

National and international transportation of cargo, freight and/or goods is a complex business and typically involves many parties and/or organizations which must cooperate together to ship the goods between destinations. The route or series by which such cargo is transported from an initial starting point to a destination location is known as or referred to as a shipping or logistics chain. The various forms of transportation by which the goods travel across the shipping chain may include ocean going vessels, over the road vehicles, rail and/or air transportation vehicles. The various different parties may be responsible for their own discrete or overlapping portions of the shipping chain.

For example, the parties may include shippers, carriers, consignees, freight forwarders, custom house brokers, cargo agents, service providers, warehouse operators and the like. Shippers might initiate the shipment of goods by booking the shipment with an international carrier. The shipper may then need to arrange for cargo agents to pick up goods at their place of origin and deliver the goods to the carrier's place of departure. When shipping internationally, it may be necessary for customs officials to hold and inspect the goods.

Prior art efforts have been made to provide computer-based systems that can track the location of goods as they are directed along the shipping chain. Further, some of these prior art systems attempt to organize and manage the shipping process. To effectively manage the shipping process, the system should account for or recognize most if not all of the transportation and handling links in the shipping chain. It is also desirable that most if not all of the different parties involved in the shipping process be able to participate in these systems. In other words, the system should facilitate collaboration between the parties, while also providing visibility to each of the parties involved about the other aspects of the shipping chain.

### BRIEF SUMMARY OF THE INVENTION

The disclosure provides a computer-implemented system and method for monitoring and managing the shipment of cargo, freight and goods within a shipping chain. The system enables the multiple different parties participating in the shipping venture to interact together in a manner that coordinates and directs the overall shipping cycle. The system thereby facilitates integration and collaboration between the various parties to a shipping chain. Each party defines its own particular role or process by way of events and milestones that must occur and can define their expectations such as expected time or location for these events and milestones to occur. The system supports electronic representations of these events and milestones for each and all of the parties' processes. The events and milestones for each of the parties can be linked to the related or interdependent events and milestones of the other parties via a subscription model. As the shipment of goods progresses, the corresponding events and/or milestones are realized or actualized. This realization of earlier events in turn triggers or drives interrelated or subscribed to events and milestones. Hence, the system is event driven with the occurrence of events triggering other events and realizing milestones among the various parties' processes.

The system can also manage exceptions that might occur within the processes representing the shipping cycle. For example, when the realization of an event or milestone does not occur as expected, the system recognizes that an exception has occurred and can alert or warn the interested parties so they can take appropriate remedial action. Moreover, based upon the predefined expectations for the events and milestones, the system can update, revise, or re-plan the future events and milestones and notify the interested parties of the revised processes. Further, the system can provide analysis reports based, for example, upon historical data of similar shipping cycles for evaluation by the parties.

An advantage of the disclosed system and method is that they provide greater collaboration and visibility among the parties of concern with the shipping process. A related advantage of the disclosure is that it may facilitate and simplify the workflow and verification processing within and between parties to the shipping process. This and other advantages and features of the disclosure will be apparent from the following description and the accompanying drawings.

### BRIEF DESCRIPTION OF THE DRAWINGS

FIG. 1 is a schematic diagram representing the computer implemented system for monitoring a shipping cycle, including core domains and party domains.

FIG. 2 is a schematic diagram of the core domain of FIG. 1.

FIG. 3 is a schematic diagram of an exemplary party domain of FIG. 1.

FIG. 4 is a pair of process charts illustrating and comparing the different processes that might be used by different parties to the shipping chain.

FIG. 5 is an embodiment of a process chart illustrating how the chart may be configured to provide alerts to the parties.

FIG. 6 is a schematic diagram illustrating how the party processes may subscribe to events and/or milestones in the core processes within the core domain.

FIGS. 7, 8, and 9 are schematic diagrams representing the event driven interaction within the system.

FIG. 10 is a schematic diagram representing another embodiment of the event driven interaction through the system.

FIG. 11 is a schematic diagram representing another embodiment of the event driven interaction through the system.

FIG. 12 is a schematic diagram representing how the logistics processes supported by the system may project, revise and update the related milestones and events.

FIG. 13 is a schematic diagram representing how the system can monitor and manage exceptions to the events and/or milestones falling outside of expectations for those events and/or milestones.

FIG. 14 is a schematic diagram representing how the system can analyze and learn from the shipping cycle to provide suggestions for re-planning the processes.

FIG. 15 is a schematic diagram representing how a party to the system may organize and allocate internal responsibility for providing information and responding to event occurrences and milestone realizations in the system.

FIG. 16 is a schematic representation of a shipment folder that can organize and present documentation associated with the shipping chain.

### DETAILED DESCRIPTION OF THE EMBODIMENTS

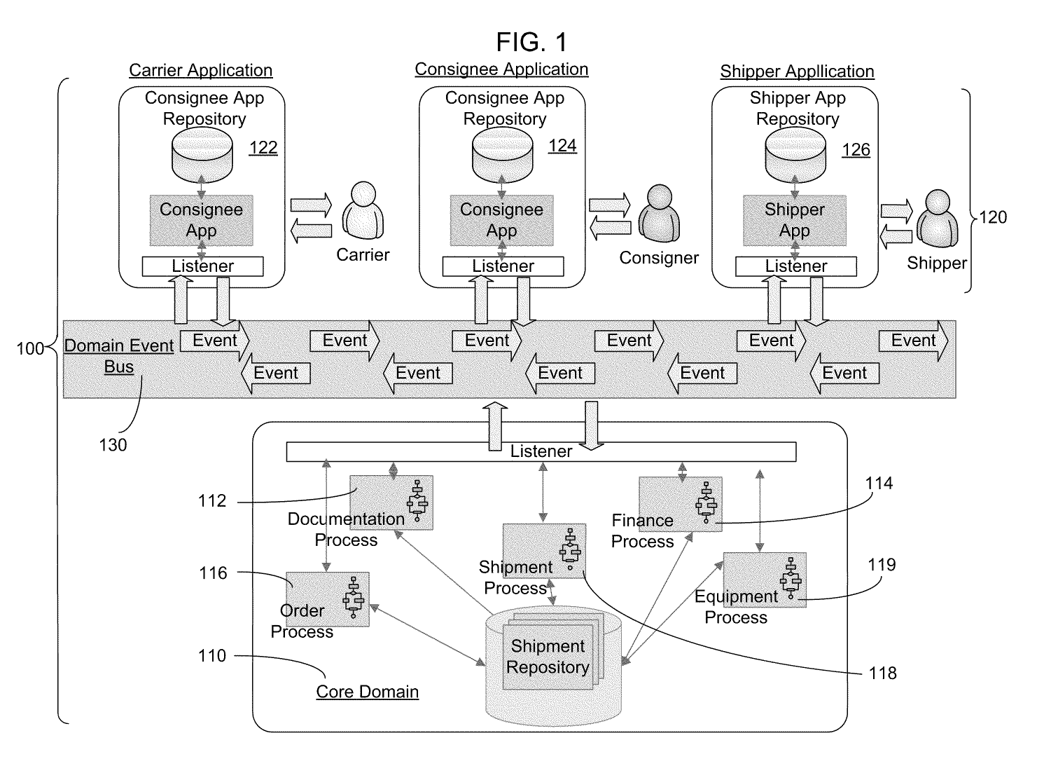

Now referring to the figures, wherein like reference numbers refer to like features, there is illustrated schematically in FIG. 1 a depiction of a computer-implemented system 100 for monitoring and managing the shipment of cargo, freight and goods within a shipping chain. The system 100 enables the various parties involved in different roles within the shipping chain to monitor the progress of the shipment as it progresses through the shipping chain. In this sense, the system 100 can function as an Electronic Data Interchange (EDI). To facilitate this, the system 100 includes a core domain 110 in which electronic representations of various processes that may be part of the actual shipping cycle are managed. The representative processes may include a documentation process 112, a finance process 114, an order process 116, a shipment process 118, and an equipment process 119. The software that makes up the core domain and the party domains can reside on one or more servers accessible via the internet or via other network systems. Moreover, the core domain and party domains can be on the same or separate servers or computer systems.

### Multi-Party Interaction

In addition to the core domain 110, the system can include a party domain 120 through which one or more of the parties to the shipping chain interact with the core domain 110 and with each other. Parties to the shipping process may include, for example, shippers, carriers, consignees, freight forwarders, custom house brokers, cargo agents, service providers, warehouse operators, suppliers, buyers, etc. Each party can interface with the core domain 110 via a computer application specific to that party. For example, the system 100 may include a carrier application 122, a separate consignee application 124, and a separate shipper application 124. The software for supporting the applications 122, 124, and 126 may reside on the same server that supports the core domain 110 or on different servers. The parties themselves can access the system and communicate to it via their applications by any various communication methods such as internet browsers, Electronic Data Interchange (EDI), Short Message System (SMS) via cellular networks, or Voice Activated Response Update (VRU). Because the parties interact with the system through the party domain 120, they cannot directly alter or change the core processes represented in the core domain.

The core domain 110 and the party applications 122, 124, and 126 communicate with one another via a domain event bus 130. The domain event bus 130 is the information backbone of the system through which information regarding the shipment and its progress are communicated back and forth between a particular party application, the core domain and between other party applications. Thus, to accommodate shipping cycles of varying complexity, the system is scalable in that the event bus 130 links together the core domain 110 and any desired number of parties to the party domain 120. As the shipping chains increase in complexity, additional parties can be added to the system by linking to the event bus 130 thus making the system extensible. In this sense, the system is multilayered with a user accessible top layer in the party domain 120 and a central or core layer in the core domain 110 which interact together via the intermediate event bus 130. The particular information transmitted over the event bus may be about various events occurring as part of the shipping cycle. In this sense, “events” are the business transactions defining the interaction and thus information exchanged between various parties along the shipping process. Parties can verify or confirm the real world occurrence or non-occurrence of the business transactions associated with the events by inputs to the system via the party applications residing in the party domain. Examples include creating a booking, amendment of a booking, and cancellation of a booking.

In addition to events, the system utilizes milestones to track shipments. Milestones are certain stages sequentially along the various logistic cycles (e.g., shipment cycle or document cycle) that should be realized by the parties as they progress through the shipping cycle. Examples of milestones are “Booking Requested,” “Booking Confirmed” and “Empty Pickup.” In this sense, milestones may be symbolic representations that an event has been or will need to be completed. A relationship between events and milestones is that an event can trigger the realization or update of a milestone. (E.g., a driver goes to a depot and picks up an empty container would trigger the update (completion) of the milestone “Empty Pickup.”) Moreover, completion of a milestone can trigger some other business processes that must be carried out by the parties. Preferably, the system can account for at least the 38 milestones and the corresponding events that are described below.

| Milestone Name | Description |
|---|---|
| Booking Requested | Shipper/Booking party submits the Booking to Carrier |
| Booking Confirmed | Carrier confirms the Booking after received |
| Custom Acknowledgement O/B | O/B Customs receives the Customs declaration |
| Custom Acknowledgement I/B | I/B Customs receives the Customs declaration |
| Custom Released O/B | O/B Customs releases the cargo/container for other parties (e.g., carrier) to |
| | pickup (or proceed with the shipment) |
| Custom Released I/B | I/B Customs releases the cargo/container for other parties (e.g., carrier) to pickup |
| | (or proceed with the shipment) |
| Carrier Released | Carrier releases the cargo/container to their customers. This indicates the liability |
| | transfer |
| SI Submitted | The SI submitted to carrier |
| BL Draft Ready | Carrier has the BL draft ready & notify shipper to verify |
| BL Original Issued | Original BL issued to shipper. For internet BL print, it is the moment that the BL |
| | ready for print |
| Empty Pickup | Trucker pickup the empty container upon the appointment & instruction from |
| | carrier |
| Empty Door Arrival | Truck arrived at Door with the empty container |
| Laden Door Pickup | After stuffing at door, trucker pickup the laden container & leave |
| Gate-in at First Full Facility | Gate-in at First Full Facility |
| Gate-out From First Full Facility | Gate-out From First Full Facility |
| Full Gate-in at 1^{st} POL | Full Gate-in at 1^{st} POL |
| Vessel Arrival at 1^{st} POL | Vessel Arrival at 1^{st} POL (Actually it's used for US trade. The checking should be |
| | Vessel Arrival at last foreign) |
| Loaded on board at 1^{st} POL | Loaded on Board at 1^{st} POL |
| Vessel Departure at 1^{st} POL | Vessel Departure at 1^{st} POL |
| Vessel Arrived at Transhipment | Vessel Arrived at Transhipment Port |
| Port | |
| Discharge from Transhipment | Discharge from Transhipment Port |
| Port | |
| Loaded at Transhipment Port | Loaded at Transhipment Port |
| Vessel Departure at | Vessel Departure at Transhipment Port |
| Transhipment Port | |
| Gate-out from Last POD | Gate-out from Last POD |
| Vessel Arrival at Last POD | Vessel Arrival at Last POD |
| Discharge at Last POD | Discharge at Last POD |
| Gate-in at Final Hub | Gate-in at Final Hub |
| Gate-out at Final Hub | Gate-out at Final Hub |
| Container Available | The Container available for responsible party pickup after releases at destination |
| Container Vanned | Container Vanned (can be happened at different locations) |
| Container Devanned | Container Devanned (can be happened at different location) |
| Laden Door Delivery | Truck delivered the laden container to destination door |
| Empty Door Departure | After discharging the cargo at destination door, trucker departed with the empty |
| | container |
| Container Returned to carrier at | Empty container returned to carrier at destination |
| Destination | |
| Container Transferred | Carrier transferred the container to a new one may be due to container damaged |
| Customs Held O/B | O/B Customs held the container due to some problems with the container |
| Customs Held I/B | I/B Customs held the container due to some problems with the container |
| Carrier Held | Carrier held the container & not released to the customer |

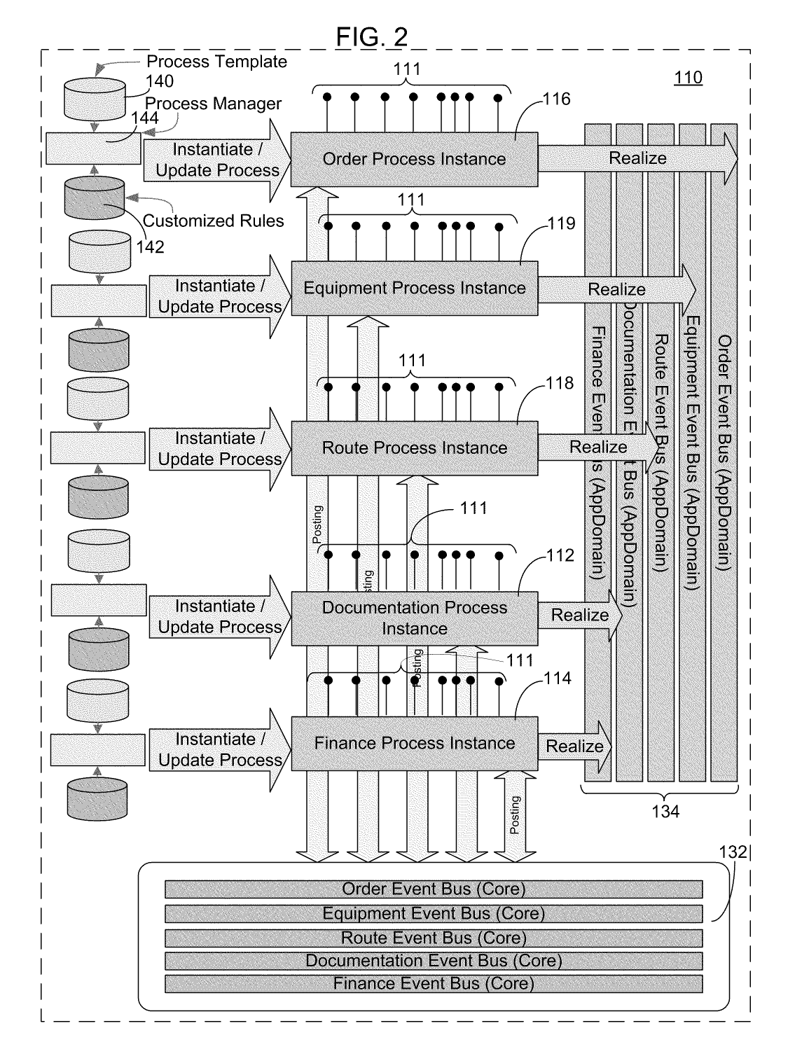

Referring to FIG. 2, in a preferred embodiment, the core domain 110 can host and manage the various processes that must be carried out such as the documentation process 112, a finance process 114, an order process 116, a shipment or route process 118, and an equipment process 119. The core domain 110 should store the full set of events and milestones for each core process. These events and milestones may be represented by the dots 111 associated with each of the core processes 112-119 and can be representative of or associated with the real world occurrences in the shipping chain. The core processes can be determined by predefined process templates 140 and customized business rules 142 typically associated with that logistics process. These process templates 140 and customized business rules 142 define the standard event and milestone sequence/dependency for the logistics processes in the core domain 110. Each process therefore can be an electronically generated and maintained representation or embodiment of the order and sequence of real world events and occurrences for a particular aspect of the shipping chain such as documentation or financing. A software based, process manager application 144 may utilize the process templates 140 and customized business rules 142 to initiate the core processes 112-119 in the core domain. The different core processes 112-119 may communicate or propagate events among themselves by transmitting data and information in the form of electronic signals via a core event bus 132 that interlinks the core processes. To communicate with the party domain, the core domain 110 may also include a core/party event bus 134 which may be part of the event bus 130 of FIG. 1 that communicates and propagates events to the party domain.

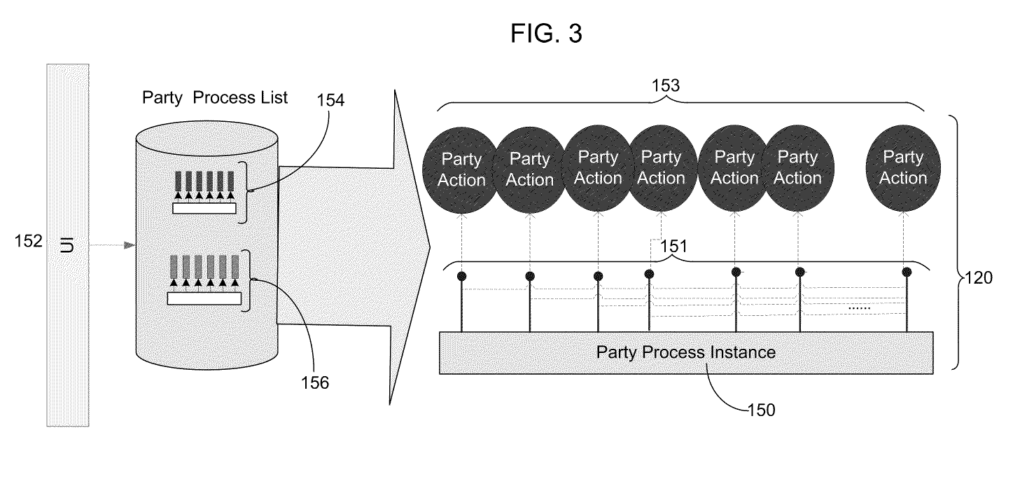

In addition to the core processes, each party participating in the shipping cycle will have its unique logistical process that the particular party must perform. Referring to FIG. 3, electronic representations of these party processes 150 can be hosted in the party domain 120 and can be defined by the various milestones that the particular party must accomplish. The milestones may be represented by the dots 151 and may be associated with or representative of real world actions 153 with respect to the shipping chain that the party must perform. As indicated, the milestones may be sequentially or chronologically spaced apart indicating the temporal order and relation between the various real world actions. Moreover, even though the all the milestones for a particular party may be represented in that party's process, the real world actions may be conducted at various different physical locations. To create the electronic representation of the processes 150, the party working through a party user interface 152, which maybe a computer based application such as an internet or web portal, can select from a standard predefined process set 154 or template consisting of pre-selected milestones or that party can develop a customized process set 156 that assign party actions and customized milestones based on that party's particular operational model. The party domain 120 creates the electronic representation of the party process 150 based upon that information. Using the user interface, a party can view and monitor the milestone realizations and event triggers that electronically represent progress of cargo in the shipping chain. The process templates or sets can be saved for future use.

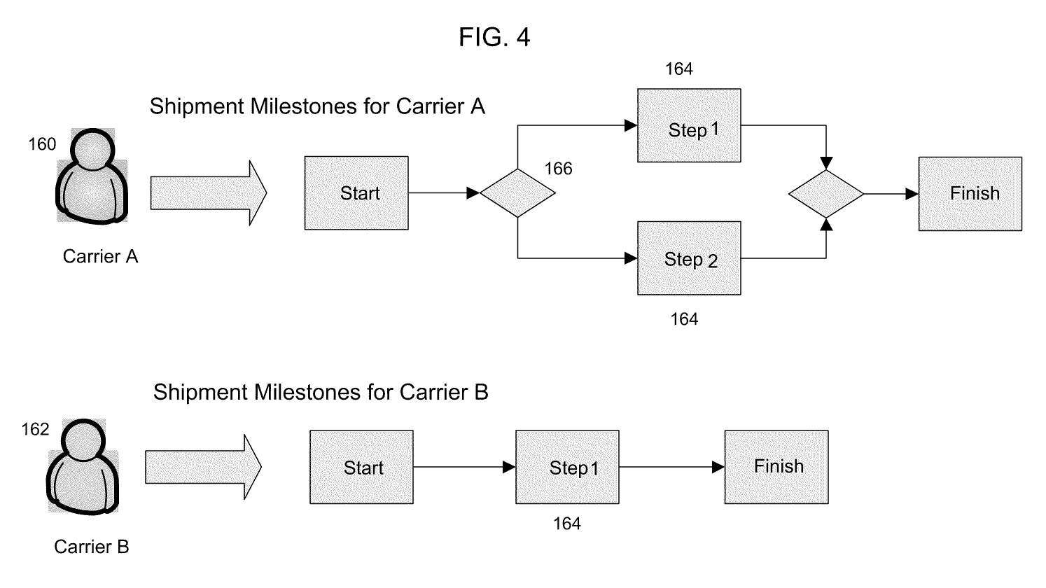

Referring to FIG. 4, customization of the party processes provides the capability of parties such as, for example, two different shippers 160, 162 to define their shipment milestones 164 within the system to correlate with their particular business process flow and their specifically identified shipping routes. Hence, the party domain can support various different processes for the different parties with different events and milestones that may be specific to that particular party. For example, the process for party 160 may include a branching instance 166 that causes the simultaneous realization of two subsequent milestones 164 that may not occur or be necessary during the process for the second shipper 162 due to their particular operation model. Moreover, the parties can adjust their processes to reflect changes in shipping. This also allows the parties to adapt the electronic representation of their processes to their latest business practice and to adjust their milestone/event modeling for any new or specifically desired milestones due to changes in business needs or logistics setup. The customized processes can be built into the party domain over time and become the “base line” processes that parties can select to identify their unique logistical cycles. Any customization of or changes to the party processes or milestones may be reflected in the core domain so that the core stores a complete set of milestones for the shipping chain. In other embodiments, the core domain and the party domain may diverge with respect to the events and milestones each reflects.

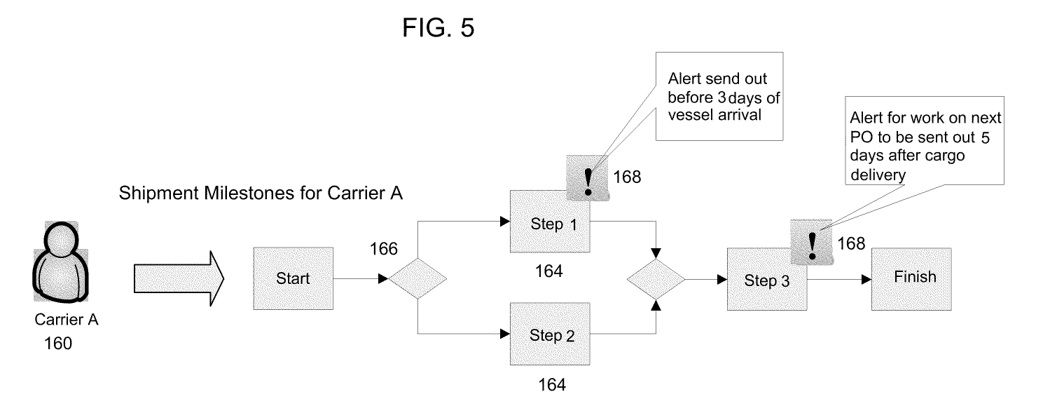

In addition to customization, referring to FIG. 5, the system enables parties in their processes to set alerts before the milestone and/or event occurs in order to trigger any preparation work, or to set alarms afterwards to arrange for any follow up action. In the process for shipper 160, alerts 168 may be associated with various milestones 164 and may be triggered by the realization of the milestone. Additionally, the alerts may be triggered by the system's monitoring of prior events and milestones or by an anticipation of the realization of that milestone. For example, an alert can be sent out three days before the arrival of a vessel. Another alert can be sent out five days after delivery to begin working on the next cargo delivery. Alerts can be sent to the party by, for example, e-mail or other reminder.

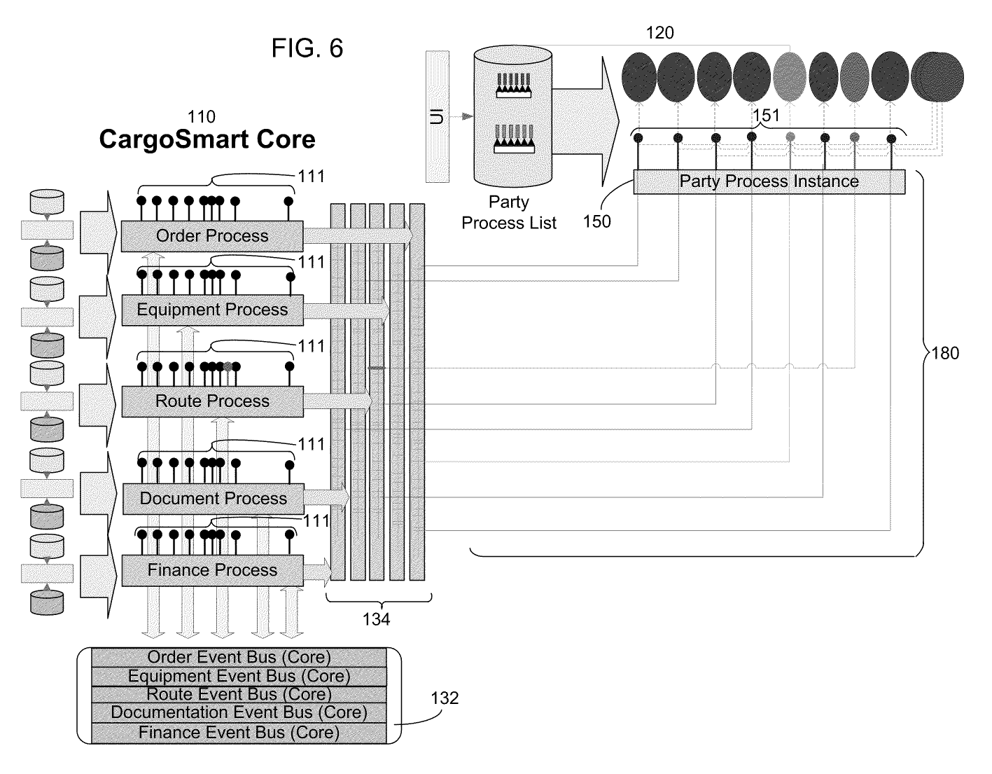

Referring to FIG. 6, the relationship by which party processes in the party domain 120 are affected by core processes in the core domain 110 can be based upon a subscription model. In this embodiment, a party can subscribe its process to a corresponding core process. In the particular embodiment illustrated, each milestone 151 in the in a party's process 150 residing in the party domain 120 is linked by subscription to the relevant core processes and the events 111 propagating through the core domain 120. In FIG. 6, the subscriptions between the party processes and the core processes can be indicated by the links 180 as shown. The links 180 may be part of the event bus 130 depicted in FIG. 1. Hence, a party can choose to only subscribe to those core events and milestones in which it is interested and the party can chose to remain oblivious to other core process in which it is uninterested. When the business function associated with each milestone is preformed by the appropriate party, the party will verify the same with the system and the result of the business event will be communicated to all interested business parties via the subscription model. Some of the parties may provide responses to the occurrence and post their response back through the system. To facilitate the subscription model, the milestones within the party's processes in the party domain can be customized to correlate with specific and multiple core events. Additionally, the party can associate certain conditions or “expectations” with the milestone in the party process such as timing, due date, or location parameters. Associating expectation parameters with the milestones and the events that trigger them enables many further features of the system described herein. As mentioned above, a party can also customize its particular processes to update for new routes and account for new events. These changes to the party processes may be communicated back to the core domain to update any corresponding core processes and can be passed onto the other interested or effected party processes.

### Event Driven Interaction

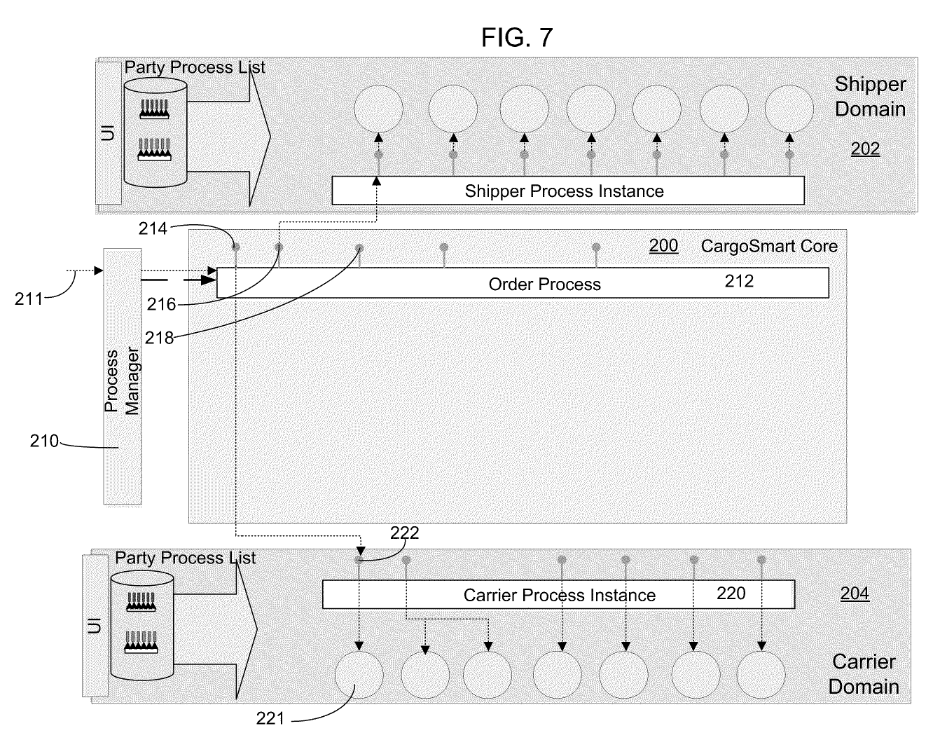

The interaction between the core domain and the party domain, and the respective processes included in each, can be driven by an event-occurrence based model. By way of example only, referring to FIG. 7, there is illustrated the relationship within the system between the domain core 200 and the party domain for two separate parties, for instance, a shipper domain 202 associated with a shipping party and a carrier domain 204 associated with a carrier party. At the start of the shipping cycle for a particular shipment, there may be no existent core processes within the core domain 200. When the shipping party places a booking request for the shipment indicated by arrow 211, the process manager 210 associated with the core domain 200 recognizes this as an order related event and therefore initiates or creates an order process 212 within the core domain. When the order process 212 is initiated or created, it can include various order events (“BKG Req. 214,” “BKG Cnfm, 216” “Job Order Issued 218”) arranged sequentially, based upon the pre-defined templates and/or business rules associated with the process manager 210. Receipt of the booking order also causes the first event, the BKG. Req. event 214, to be realized.

Within the carrier domain 204, an electronic representation of the carrier process instance 220 with various associated milestones for the carrier party are supported. The carrier process instance 220 may have subscribed to the BKG Req. event 214 in the core domain 200. Because of that subscription, the BKG Requested milestone 222 of the carrier process instance 220 is triggered or realized. Realization of the BKG Requested milestone 222 triggers the carrier party to take corresponding actions, such as to process a booking (Process BKG 221).

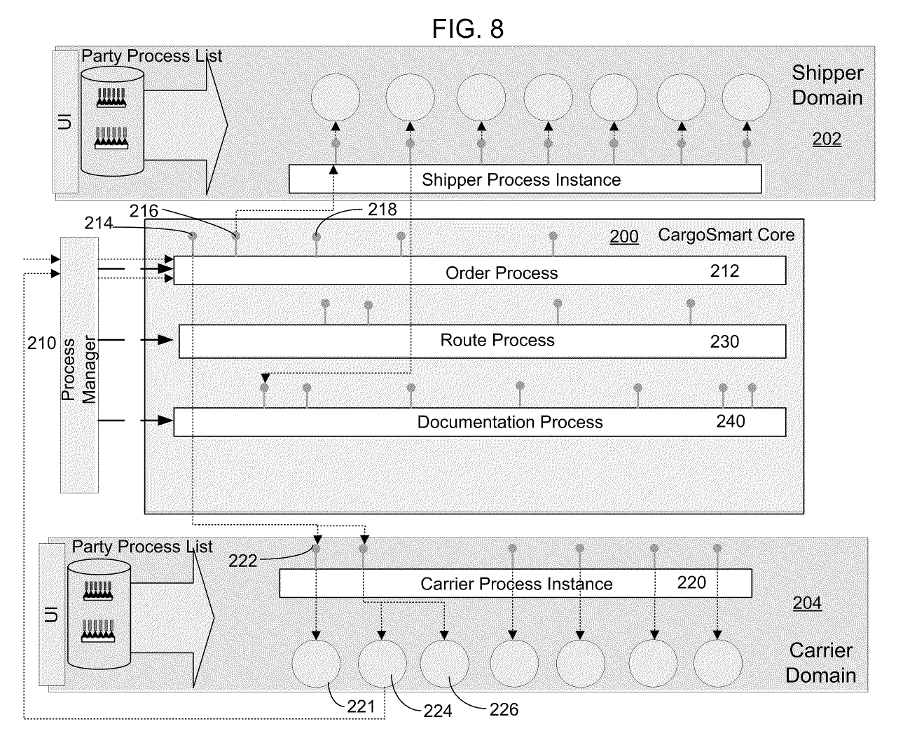

Referring next to FIG. 8, a certain time such as 24 hours after the BKG Requested milestone 222 is realized in the carrier domain 204, another two actions or events are triggered along the carrier process instance 220. These actions or events are a Confirm BKG event 224 that confirms the shipment booking and an Issue BA event 226 which issues booking advice. The carrier party performs the real world acts corresponding to these events. These two events are communicated or confirmed back to the process manager 210 of the core domain 200.

Triggered by the Confirm BKG event 224 from the carrier domain 204, the process manager 210 in the core domain 200 realizes or acknowledges in the order process 212 a BKG Cnfm milestone 216 noting that the booking has been confirmed. Also, when the BKG Cnfm milestone 216 is realized, the process manager 210 will trigger the initiation or creation of a route process 230 and a documentation process 240 within the core domain 200. The route and documentation process 230, 240 can be based on the pre-defined templates and/or customized business rules defined within the process manager 210 by the parties on event dependencies. The predefined rules can be such that whenever a Confirm BKG event 224 is received by the order process 212 then it is expected that the route process 230 and the documentation processes 240 should be initiated. So, the route and documentation process 230, 240 are created with their planned events and milestones.

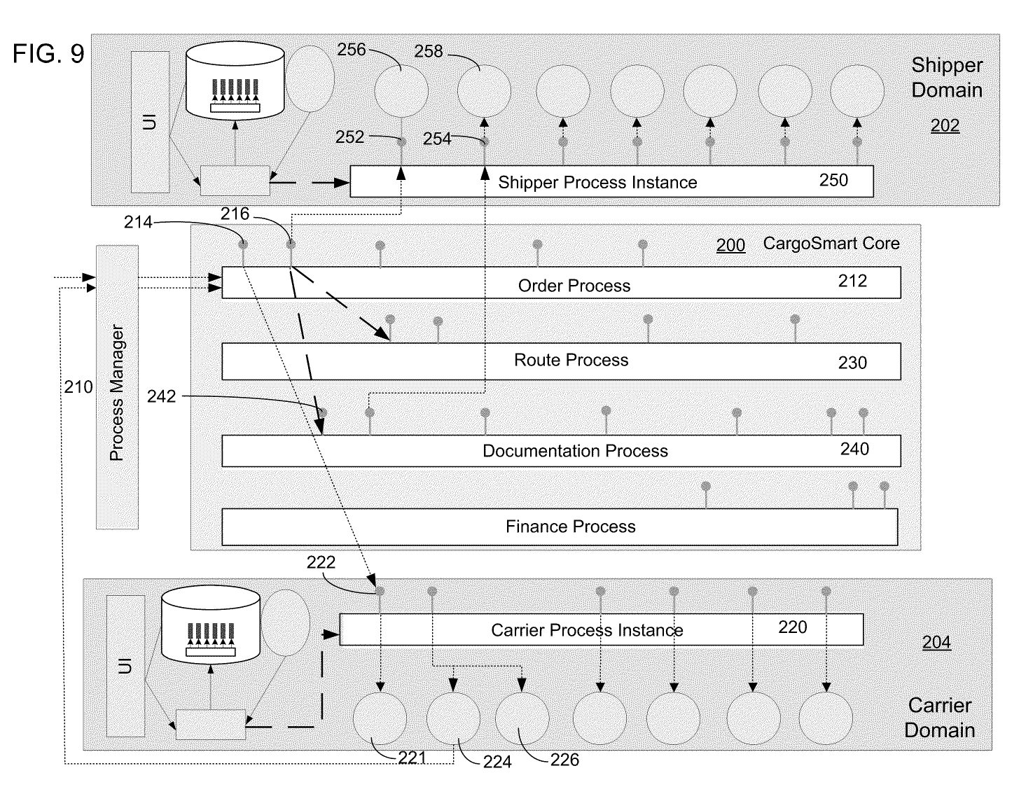

Also, referring to FIG. 9, in the Shipper Domain 202 the shipper process instance 250 will note that the BKG cnfm event 252 (booking confirmation) has occurred due to subscription to the BKG Cnfm milestone 216 in the order process 212 and will trigger the shipper to take certain actions, for example, to arrange a terminal movement for containers with their vendor 256. Upon the occurrence of the Issue BA event 226 in the carrier domain 204, it triggers the realization of a BA Issued event 242 in the documentation process instance 240 within the core domain 200. This also triggers in the shipper process instance 250 the realization of a BA Issued milestone 254 that in turn triggers, for example, the action Forward BA to vendor 258.

With that continuous triggering of events and realization of milestones in response to actions from different parties, events as they occur enter the domain core and are propagated to each party process based on that party's interest and the events and/or milestones to which they have subscribed. The triggering of subscribed to events and milestones initiate certain dependent or defined party actions. The core therefore can maintain and track all of the milestones and events and the parties are only notified or kept informed of that information according to their level of interest via the subscriptions. This is the basis of system's event driven model.

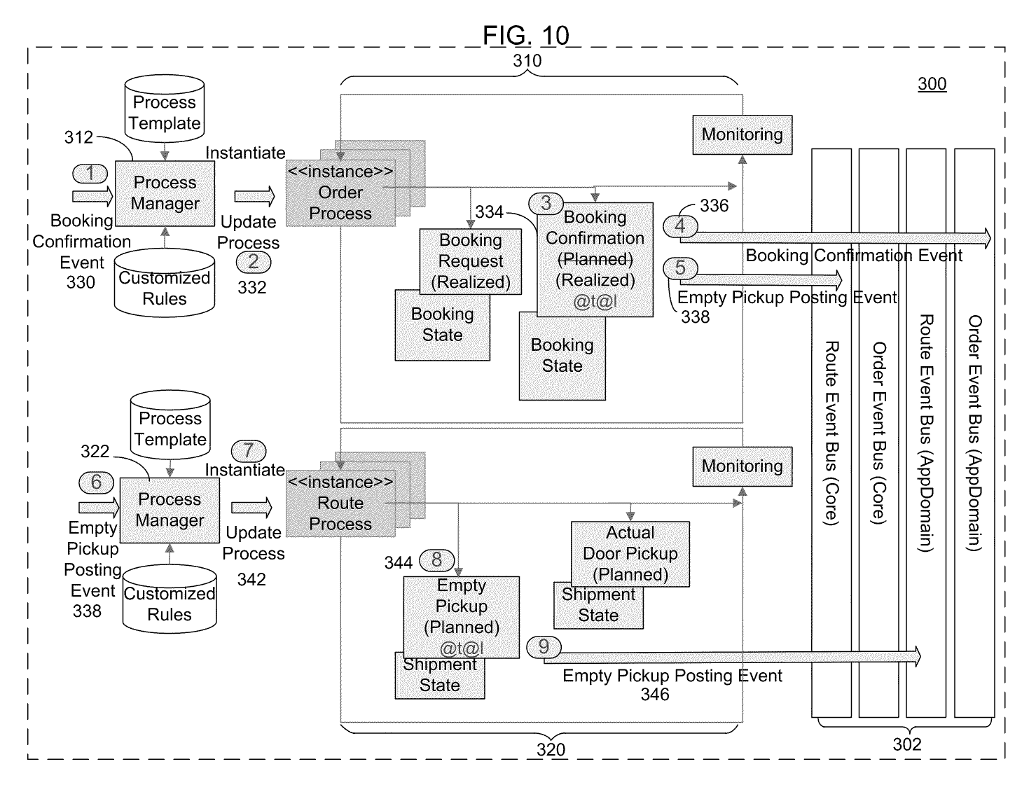

A further example of the event driven architecture is provided in FIG. 10, which shows the event driven interaction between milestones based upon the dependency/triggering logic built into each milestone. The event occurrences are communicated through an event bus 302 or a plurality of differentiated or dedicated core event buses which can be highly de-coupled allowing complex communication between interdependent events among the different parties. Whenever an event goes into the core domain, it coordinates updates to the various core processes by posting the propagated events to the core event buses. In FIG. 10, an example of the communication of events via the event buses is illustrated. A booking confirmation event 330 received by the process manager 312 for the order process 310 triggers updates 332 to the order process in the core domain 300. In response to the updates, the milestone “booking confirmation 334” reflects its realization and in turn posts two events to the core systems buses 302, a “booking confirmation event 336” and an “empty pickup posting event 338.” The “empty pickup posting event 338” is re-received by the process manager 322 for the routing process 320 via the core event bus 302 to trigger updates 342 to the routing process including realizing an “empty pickup milestone 344” and triggering an “empty pickup event 346.”

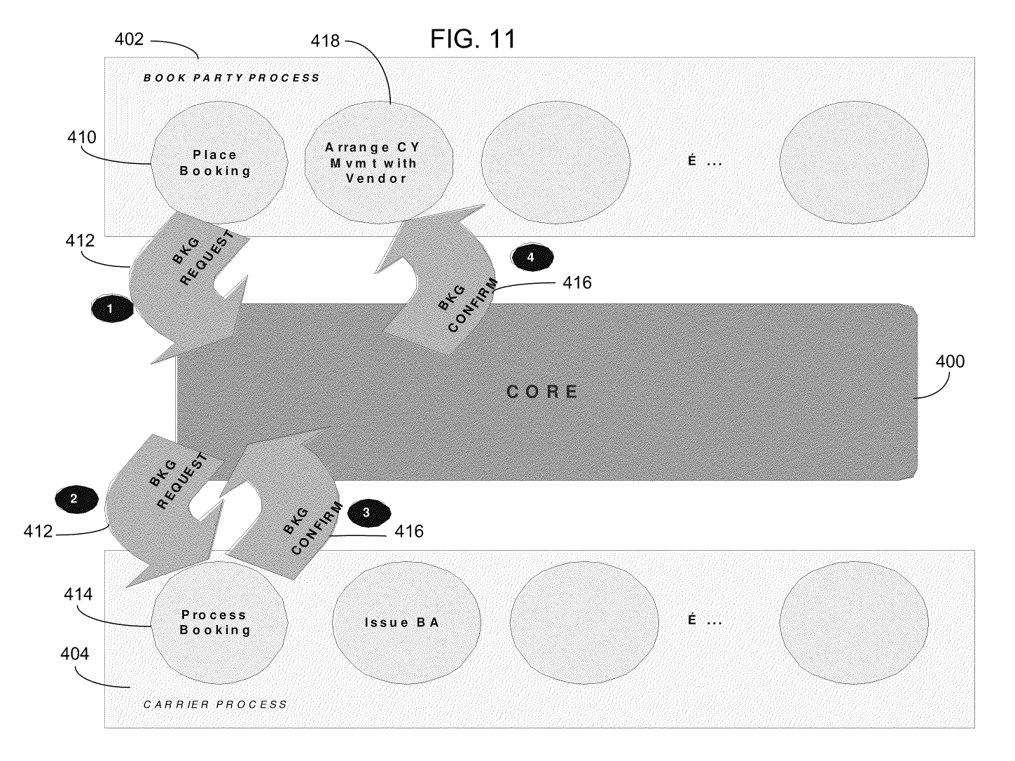

A further example of the interaction and communication between the different party domains and core domains is provided in FIG. 11, which illustrates several processing steps between a booking party and a carrier party. In step 1, the booking party performs the first action in the booking party's process 402 by creating or placing a booking that realizes the “Place Booking milestone 410” which is sent to the core domain 400 as a “Booking Request event 412.” The “Booking Request event 412” is communicated through the core domain 400 and onto the carrier domain 404 where it is realized as a “Process Booking milestone 414”, which in step 2 triggers the corresponding carrier action to process the booking request. Once the carrier party approves of “Booking Request event 412” and completes the Process Booking Request action,” in step 3 a “Booking Confirmation event 416” is triggered and sent from the carrier domain 404 to the booking party domain 402 through the core 400. Receipt of the “Booking Confirmation event 416” is realized in booking party domain 402 which, in step 4, triggers the “Arrange CY Movement with Vendor milestone 418” causing the booking party to arrange a trucking order with a vendor. The forgoing example demonstrates the pattern of continuous triggering of events in response to actions from different parties. Events created by a party's action are communicated via the core to the other interested party processes and realize milestones that initiate actions by those receiving party actions via the event driven concept.

### Expectation and Forward Re-Planning

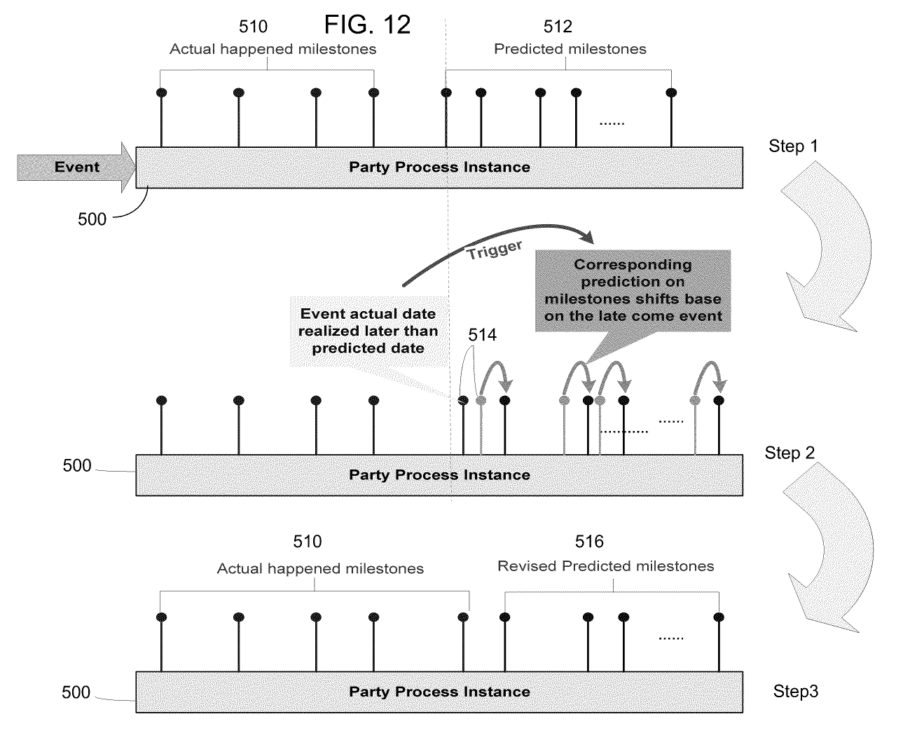

The event driven model can enable various beneficial features within the system. For example, referring to FIG. 12, the system can enable management by expectation and forward re-planning. The parties define their expectations regarding timing or location of the events and/or milestones in the various party processes 500 so that the party processes keep track of all the events and milestones including those that have occurred or been realized, i.e. actual happened milestones 510, and those that are expected to occur or be realized in the future, i.e., predicted milestones 512, such as illustrated in Step 1 of FIG. 12. The expectations can be custom set by each party depending upon their particular business model and turnaround times. The spacing between milestones may reflect the expected timing in the sequences of events and occurrences. The system will be able to master the sequence of the shipment events to prepare a process template. Based on this process template, the system can be able to predict and plan the upcoming events for a shipment. As a related feature, the expectations assigned to the milestones and the duration of time between realized milestones can be analyzed by the parties to evaluate service level or turn around time between milestones. This information can be used by the parties to determine more realistic expectations between the milestones and to revise the party process templates accordingly.

However, shipment details might change from time to time. The system can re-plan the events and milestones for the parties for every change to a particular shipment, as indicated in step 2. A particular event or milestone 514 may actually be realized later than expected. The party process 500 may shift the expectations for the upcoming predicted milestones 512 by the amount of delay for the late realized event or milestone 514. Therefore, the system can re-plan and reflect the latest or revised expectations for the events and milestones to the parties (i.e., shifted forward or backward). As indicated in step 3, the newly revised party processes 500 accurately reflect the revised predicted milestones 516 and those are then made available for monitoring by the system and the parties.

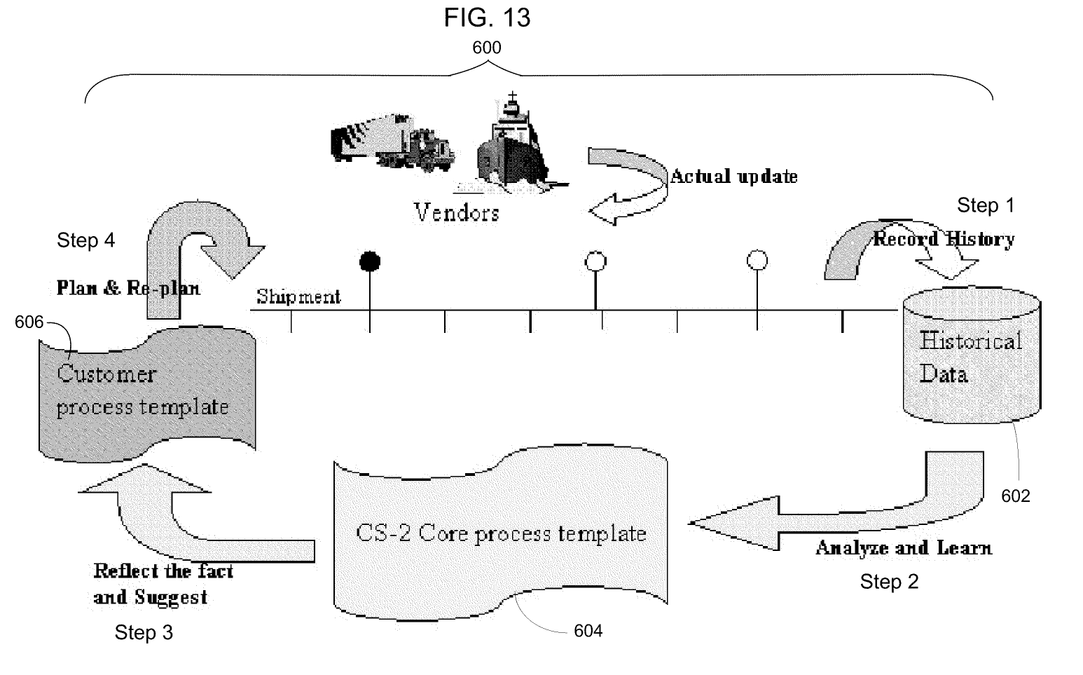

In conjunction with the forward re-planning function, referring to step 1 of FIG. 13, the system can process and analyze the historical data of the various parties to learn and understand the relationships between events, occurrence times, and patterns. Data monitored and generated by the system 600 during previous shipping cycles can be stored in an historical database 602. The historical database 602 can take the form of computer accessible or searchable electronic or magnetic storage. The monitored data can correspond to the realization of milestones as triggered by event occurrences, including the exceptions such as delayed, missing or out of sequence exceptions as described below. The system 600 may include logic, algorithms or software implemented analytical tools that can analyze the historical database 602 to learn the event and milestone relationships, time occurrences and patterns, as indicated in step 2. The system can use the learned results of the data analysis to update the process templates in the core domain 604. In step 3, the results of this analysis of data can also be provided to the parties so that they can change their process templates 606 in the party domain accordingly to reflect the latest, real world, behavior of the other parties to the shipping venture. In a sense, the system will have intelligence to learn the behavior of different parties to reflect and provide suggestions to the parties for a more realistic process flow. In response to this analysis and learning, as indicated by step 4, the parties can customize their process templates 606 from time to time. This can help the parties understand each other's positions and the norms of the markets such that parties can react according to the changes of the market or economy. Parties then can have a more accurate understanding of shipment plans as well as a more accurate expectation of the upcoming events.

### Exception Management

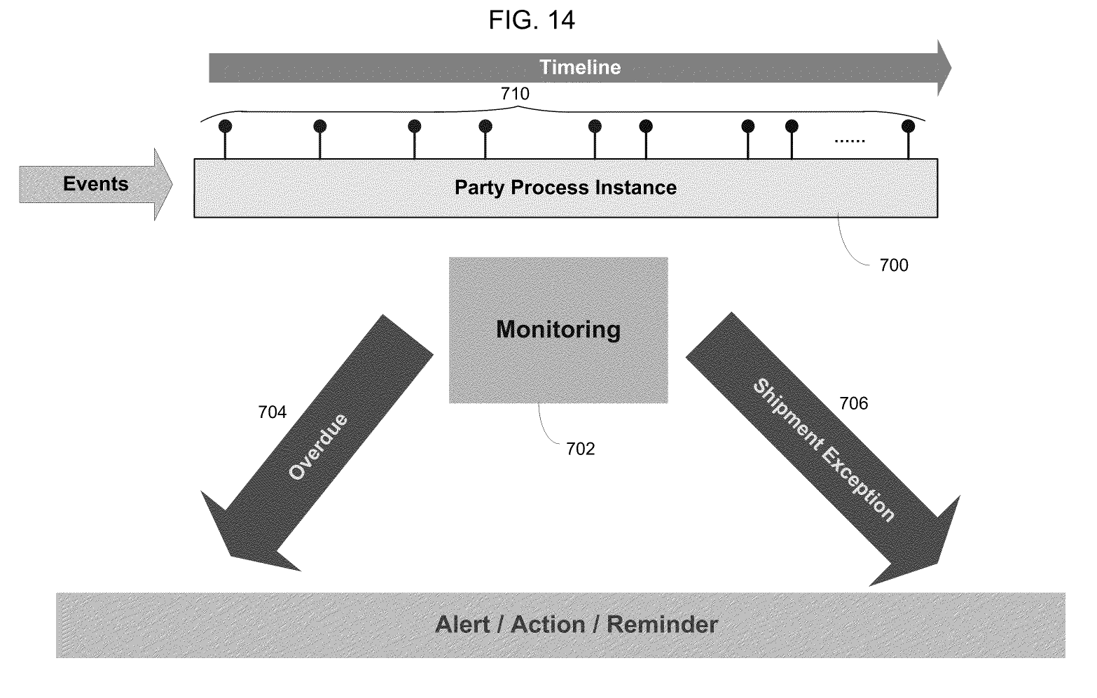

The system also enables parties to manage their roles with respect to the shipping cycle by exception. Typically, if nothing wrong occurs to the shipment of goods, the parties generally will not care about what the shipment is doing. However, referring to FIG. 14, the system keeps monitoring the shipment and can proactively inform or alert the parties if an “exception” occurs which falls outside of the predefined expectation for an event or milestone. Once the party has been alerted about the exception, the party can take action regarding the exception immediately, which can minimize the turn around time for problem solving.

Types of exceptions can include (1) overdue or delayed events or milestones; (2) missing events or milestones; and (3) illogical sequence of events or milestones. Referring to FIG. 14, the monitoring function 702 will monitor the sequential occurrence of predicated events and realization of milestones 710 programmed into a party's process 700. The system will consider an event or milestone overdue if the event or milestone has not been updated within the expectation of the party, and the system will notify the interested party accordingly via an overdue alert 704. If the event or milestone occurs later in time than was expected by the party expectation, the system will consider this a delayed exception and likewise notify the party accordingly via a shipment exception alert 706.

Based on its knowledge of the events, milestones and party expectations, the system can define the process sequence. If an event or milestone has not been realized within an expected timeframe, the system considers this as a missing event exception and likewise can notify the party or parties to take appropriate action. Also based upon its knowledge of the predefined event and milestone sequence, the system can detect illogical shipping sequences when there are event or milestone occurrences that violate the parties predefined event and milestone relationships. The monitoring function can send other types of alerts to notify parties of other types of exceptions. The system can thus help parties monitor the shipment flow and be sure that all information being provided is correct. To monitor for exceptions, a shipping plan just keeps a list of events expected to occur and the time of their expected occurrence (i.e. monitoring for delayed events) or keep a list of future events whose status should be dependent upon the expected present event (i.e. monitoring for missing or out of sequence events).

### Analysis and Reporting

The system can also provide analysis reporting on the shipping cycle. For example, the report can provide a snapshot of a shipment at a given time. The data obtained about the shipment from that snapshot can be presented in formats such as columns and can focus on particular areas, routes or services. The reports can also compare the snapshot of a particular shipment with snapshots of previous shipments or with respect to a pre-defined base requirement for evaluation. Additionally, the reports can compare and contrast parties, such as comparing different carrier parties. The parties can use the reports, along with information regarding any exceptions, to refine their process templates. Successful process templates can be shared among the various parties.

### Party Interaction

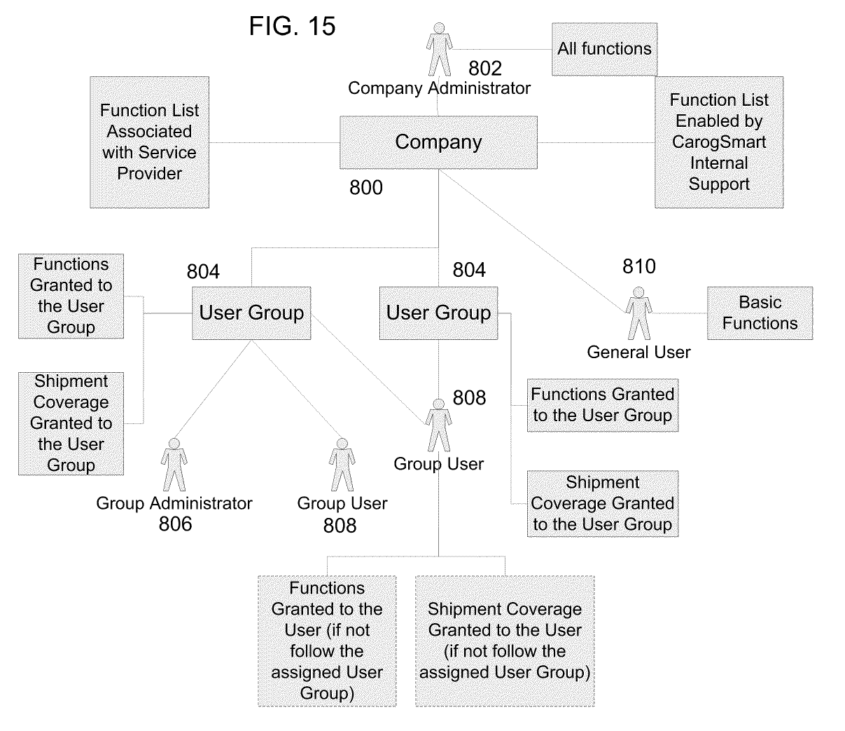

At a more specific level, the party domains and/or party applications can be configured with features for the benefit of the party's interaction with the system. The parties can interact with the system via any suitable communications medium, including internet browsers, Electronic Data Interchange (EDI), Short Message System (SMS) via cellular networks, or Voice Activated Response Update (VRU). Referring to FIG. 15, there is illustrated schematically a profile of how specific responsibilities within the party domain may be allocated. The party profile for each company or party 800 may have one administrator 802 who may in turn set up numerous user groups 804 in which each group is assigned a group administrator 806. In the system, the functions and responsibilities are assigned unallocated for each party. In turn, the administrators 802 may assign group users 808 and individual users 810 with specific functions, and the group administrators 806 may further assign functions and shipment coverage filtering to their respective groups. In this manner, the administrators and group administrators can control security and allocate responsibility within the group and among individuals for any specific milestones or events.

### Shipment Folder

Another beneficial feature the system can provide to parties for monitoring and tracking shipments can be a shipment folder. The shipment folder can be an intelligent electronic repository integrated with the system and with the party's logistical shipment plan. It enables automated definition and subsequent monitoring of “what, when and who” is needed to fulfill each documentation requirement within the parties' overall shipping chain management. In an embodiment, the shipment folder can function as a high level graphical interface through which the functions and processes of the underlying system for monitoring and managing the shipment of cargo are presented to users. The shipment folder can include embedded document review/approval functions, whereby document requesters can review documents or objects uploaded by those from whom such items are requested. This enables the parties to iterate, until completion if desired, the document review and approval cycle of the documents or objects received. The process of reviewing and approving documentation in the shipping folder enables workflow management over the shipping chain. In an embodiment, the shipment folder can also account partial uploads whereby an individual can upload numerous components parts of a single document in separate actions and the shipment folder controls the appropriation of those parts.

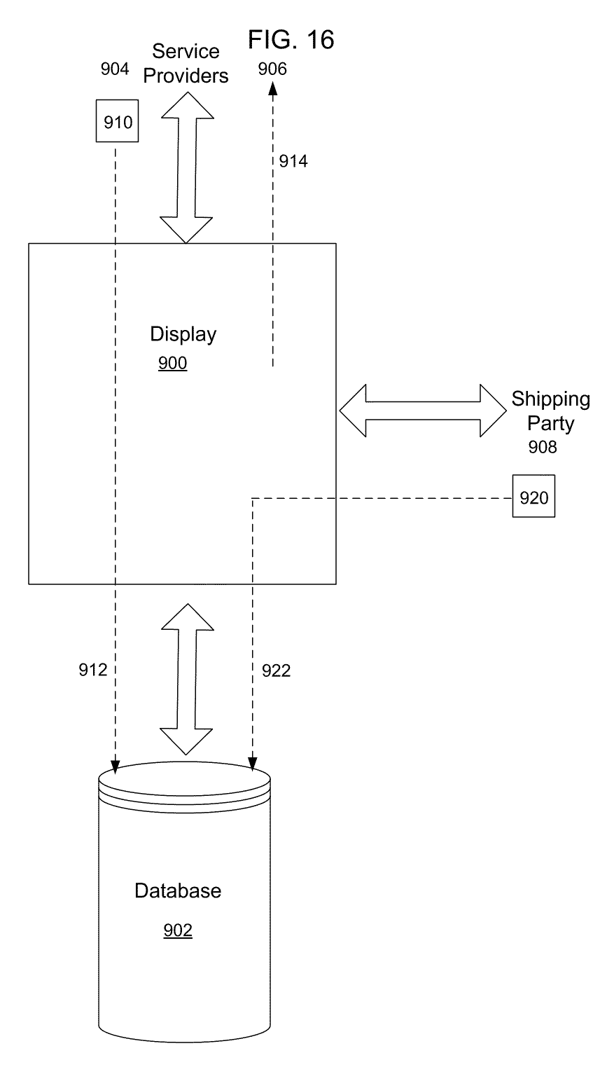

Referring to FIG. 16, there is illustrated a computer enabled shipment folder for the storage and review of documents associated with the shipping chain. The shipment folder may include instructions for generating a graphical user interface 900 that may be displayed on a computer monitor and viewable by the parties via the user interfaces discussed above. Instructions for generating the shipment folder can be stored on an internet accessible computer. Access to the shipment folder may be password protected. However, because multiple parties with correct passwords can access and interface with the user interface, the shipment folder can promote the addition of new parties to the shipping chain and promote the scalable aspect of the system discussed above. The instructions link the user interface 900 with a database 902 stored on one or more computer servers. Stored in the database can be electronic documents 910 associated with the shipping chain, such as service provider documents. Service provider documents can include documentation provided by service providers 904, 906 and other parties to the shipping chain, such as carriers, port authorities, and warehouse employees. Using the user interface 900, the service providers 904 can upload and/or review electronic copies or images 910 of the documents to the database 902 that stores the documents on the server. The service provider documents may be further categorized into service provider (provided) documents that must be provided by a service provider and service provider (required) documents that are required to initiate action on part of a service provider.

As the cargo progresses through the shipping chain, a first service provider 904 who is responsible for a portion or stage of transportation can upload documentation 910 verifying or confirming the progress of the cargo. Dashed arrow 912 depicts a service provider document 910 being electronically uploaded by the service provider 904 and stored to the database 902. When the shipment folder receives the uploaded document 910, it might identify and note the responsible service provider 904 as well as the document type and other information. In conjunction with the milestone realization, event triggering, and subscription functionality described above, the shipping folder might notify other interested parties such as other service providers 906 in the shipping chain about their particular workflow actions that those other service provider should take in response to the uploaded document. This notification to other service providers 906 is indicated by dashed line 914. These parties can then review the documentation in the shipping folder and take appropriate action. The shipping folder in this sense provides shipping chain integration and channel connectivity.

Other parties to the shipping chain such as the shipping and/or receiving parties 908 can access the user interface 900 to search and review the documents 910. To facilitate retrieval of the uploaded documents, the shipment folder may include instructions that enable the shipping and/or receiving parties 908 to search the documentation that is stored in the database and may further automatically organize and categorize the documents into subfields according to information such as document type or date of uploading. The reviewing party can mark or categorize the documents as approved or rejected. Moreover, once a document has been uploaded by the service provider, the shipment folder can categorize the document as waiting for review and can send a notification to other parties requesting them to review the document for approval or rejection. Once the shipping and/or receiving party 908 has approved the documentation, this action can be communicated back to the service provider 904 who has uploaded to the document. The service provider 904 may interpret this communication as approval to proceed with the handling and transportation of the cargo. The shipping folder may also track and provide a visual indication of the expectancy of documents to be uploaded (i.e. required documents) and the receipt of uploaded documents (i.e. completed documents) to enable the parties to monitor the shipping chain progress. Each service provider and reviewing party may delegate responsibility for uploading, reviewing and approving document in accordance with division of responsibility illustrated in FIG. 15.

In a further embodiment, the shipping party 908 may provide its own user defined documents 920 to the shipping folder which may be stored in the database 902 as indicated by dashed line 922. The user defined documents 920 may be customized by and proprietary to the particular shipping party. The shipping party 908 can later search and/or access the user defined documents 920, and may be able to combine or analyze these documents, through applications available on or supported by the system. The shipping party 908 may elect to make the user-defined documents 920 available to other parties for review or use via the display 900. The shipping party 908 may thereby integrate its own internal shipment management and workflow management operations with the system through the shipment folder by uploading its own proprietary and internal documentation to the database 902. In conjunction with the delegation of responsibility indicated in FIG. 14, the ability to store and preserve user defined documents 920 through the shipping folder enables the parties to further centralize their own internal workflow management through the system. Similar features may be made available for other parties to the shipping chain like the service providers.

Unlimited categories of documents may be defined in Shipment Folder, including Service-Provider (provided) documents, Service-Provider (required) documents and party defined (required and/or provided) documents. The latter embrace all other role-parties potential document needs. Furthermore, documents may encompass more than the standard forms associated with the shipping cycle. Documents as used herein may include spreadsheets, user notes, and communications. Further, tokens, deeds, bills and notes representative of the transactions within the shipping chain and/or effecting legal title to the cargo being shipped may also be processed through the Shipment Folder.

For Service-Provider (provided) documents, the shipment folder enables auto-generation of most common service-provider documents, e.g. Bill of Lading/Waybill/Copy Bill, e-Invoice, Invoice Statement summary, Vessel Certificate, etc. and deposits them to a Shipment Folder repository where parties can perform view and retrieval actions with respect to the documents and can provide indications back to Service Providers, e.g. BL Change Request, BL/Invoice Request for Additional Print, etc.

For Service-Provider (required) documents, the shipment folder enables a platform where parties may upload documents requested by their appointed Service Providers. The shipment folder provides background system integration channel connectivity with all the major parties to the shipping venture (especially carriers). The parties and/or their particular shipments are identified by the Service Providers when compiling their required document lists, and the Service Providers can upload those structured lists into the shipment folder.

The shipment folder receives those parties required documents lists and identifies and indicates the responsible upload parties, the document requirement due date, together with the shipment identification information.

Meanwhile, party's staff can also define those documents in the Service-Provider reserved administration areas of system where they capture/submit information which is automatically synchronized within the system. For all requested-documents subsequently uploaded by client customers, the system automatically recognizes the shipment and service provider context and triggers workflow actions to the service provider (usually a carrier) to review them in shipment folder.

Whenever the document type (specific by name, date stamp, versioning, author source) “requirement” is marked as “Completed” by Service Provider/carrier staff in their area of the shipping folder, it can furthermore be synchronized as a transaction back to the Service Provider/carrier's own system, to indicate the object has been “received” and the respective conditions have been met.

For handling of “Rejected” documents, client customers need to correct and re-upload them, and the system then triggers workflow action again to the Service Provider/carrier user to perform the review cycle again.

The third document type embraces all other roles that the parties potentially need.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer implemented system for monitoring and managing the transportation of cargo through a shipping chain, the system comprising:
a core domain including one or more core process, each core process having a sequence of events representing stages or actions associated with the shipping cycle;
a party domain including at least one party process, the party process having a plurality of milestones representing stages or actions associated with the shipping cycle, at least one party process subscribing to an event in the core process; and
an event bus communicatively linking the core domain and the party domain, the event bus adapted to communicate an occurrence of an event representing a business transaction among parties to the shipping chain between the core domain and the subscribed party process to realize a milestone.

2. The computer implemented system of claim 1, wherein the party domain includes a user interface enabling a party to verify a milestone.

3. The computer implemented system of claim 2, wherein the event bus is adapted to communicate the milestone verification to the core domain to update the sequence of events in the core process.

4. The computer implemented system of claim 1, wherein the core domain further includes a core event bus adapted to communicate the occurrence of an event between the one or more core processes.

5. The computer implemented system of claim 1, wherein expectations can be associated with the party process milestones, the expectations regarding predicted timing and/or location of a predicted realization of the associated milestone.

6. The computer implemented system of claim 5, wherein the system monitors the plurality of milestones for exceptions to the expectations associated with the milestones, the exceptions representing delay, missed or out of sequence realization of the milestones.

7. The computer implemented system of claim 6, wherein the system sends a notification of the exception to a party to the shipping chain.

8. The computer implemented system of claim 5, wherein the system monitors the plurality of milestones for delayed realization of a milestone, and the system shifts expectations for forthcoming predicated milestones.

9. The computer implemented system of claim 5 further comprising an historical database storing data about the exceptions and a software implemented analytic tool for analyzing the data.

10. A computer implemented method for monitoring and managing a transportation of cargo through a shipping chain, the method comprising:
providing a computer maintainable system including a core domain and a party domain communicatively linked by an event bus;
presenting in the core domain one or more core processes, each core process having a sequence of events representing stages or actions associated with the shipping cycle;
presenting in the party domain at least one party process, the party process having a plurality of milestones representing stages or actions associated with the shipping cycle; and
communicating an occurrence of an event from the core process to the party process via the event bus.

11. The computer implemented method of claim 10, further comprising:
subscribing the party process to at least one core process to receive communication of the event occurrence while excluding unsubscribed event occurrences.

12. The computer implemented method of claim 10, further comprising:
communicating verification of a milestone realization from the party process to the core domain.

13. The computer implemented method of claim 10, further comprising:
presenting in the party domain a second party process, the second party process having a plurality of milestones representing stages or actions associated with a second party to the shipping cycle;
communicatively linking the second party process to core domain via the event bus.

14. The computer implemented method of claim 10, further comprising:
defining an expectation with a milestone, the expectation regarding predicted timing and/or location of expected realization of the milestone.

15. The computer implemented method of claim 14, further comprising:
monitoring the plurality of milestones in the party process for an exception to the expectation, the exceptions representing delay, missed or out of sequence realization of the milestones.

16. The computer implemented method of claim 15, further comprising:
sending a notification of the exception to a party of the supply chain.

17. The computer implemented method of claim 14, further comprising monitoring the plurality of milestones in the party process for a delayed realization of a milestone, and shifting the expectations for forthcoming predicated milestones.

18. The computer implemented method of claim 10, further comprising sending an alert regarding a pending occurrence of a milestone to a party to the shipping chain.

19. A computer implemented document repository comprising:
instructions for generating a graphical user interface for displaying stored documents associated with transportation of cargo in a shipping chain;
a database for storing documents associated with transportation of cargo in a shipping chain;
instructions for enabling documents to be uploaded from remote computers to the database; and
instructions for querying the database to located and display the uploaded documents.

20. The computer implemented document repository of claim 17, further comprising instructions to categorize the uploaded documents as waiting for review, approved, or rejected.
